(19) United States
(12) Patent Application Publication
(10) Pub. No.: US 2010/0048279 A1
(43) Pub. Date: Feb. 25, 2010

(54) GAME SYSTEM AND METHOD CAPABLE OF CHANGING SYMBOLS WITH SHOWN SUPER SYMBOL

(76) Inventors: Chen-Duo Liu, Taichung City (TW); Ching-Yi Kao, Taichung County (TW)

Correspondence Address: Muncy, Geissler, Olds & Lowe, PLLC, P.O. BOX 1364, FAIRFAX, VA, 22038-1364, US

(21) Appl. No.: 12/195,961

(22) Filed: Aug. 21, 2008

(51) Int. Cl. A63F 13/00

(52) U.S. Cl. 463/20

(57) ABSTRACT

The present invention is a game system and method including a game machine, a game judge unit and a symbol judge and change unit, wherein the game machine has plural wheels arranged in an array for constituting a symbol set, and each wheel in the symbol set shows a symbol randomly. Moreover, the game judge unit judges and if the symbols of the symbol set conform to a particular rule, a particular amount of bonus game is provided. Then, the game machine runs the bonus game, and each wheel in the symbol set is capable of showing the super symbol randomly. Furthermore, the symbol judge and change unit judges the appearance of super symbol and defines a particular position for the wheel showing the super symbol. Finally, the symbol judge and change unit forces the symbols on the wheels of the particular position to change into an universal symbol respectively.

### FIELD OF THE INVENTION

The present invention is related to a game machine, and more particularly to a game system and method for improving the enjoyment of a game machine.

### BACKGROUND OF THE INVENTION

Wheel type game machine, such as slot machine and fruit machine, can provide games thereon for players, so that according to the result of alignment, the player can obtain corresponding score. Therefore, this kind of game machine is very popular.

The wheel type game machine has many wheels arranged in an array for constituting a symbol set, and each wheel can independently spin for changing the revealed symbol thereon. According to the randomly changed symbol on each wheel, the machine can constitute different symbol sets. Besides, in one symbol set, if the adjacent symbols are identical, no matter in vertical, horizontal or diagonal direction, the alignment can be formed, and the more alignments the symbol set has or the rarer the produced alignment is, the more score the player gains.

Currently, for improving the enjoyment so as to encourage the player, a universal symbol has already developed in the wheel slot machine which can be recognized as all kinds or most kinds of symbols so that the alignment can be formed more easily. That is, the player can gain high score more easily, and thus, the interest in playing the game can be increased so as to inspire the player to chase higher score.

However, in the wheel slot machine, the possibility of showing the universal symbol has to be controlled, or it will become too easy to gain the score and thus lower down the score value, but if the possibility of showing the universal symbol is too low, then it might be hard to achieve the purpose of inspiring the player. Consequently, there is the need to improve the conventional game machine.

### SUMMARY OF THE INVENTION

The object of the present invention is to provide a game system which can change the symbols according to a shown super symbol, wherein in the bonus game thereof, the symbols in a symbol set can randomly being the super symbol so as to cause symbols located therearound to change into super symbols automatically, thereby improving the enjoyment of player.

The further object of the present invention is to provide a game method capable of changing symbols in accordance with a randomly shown super symbol, wherein through the quantity limitation of bonus game and the automatic expansion of super symbol, not only the enjoyment of player can be increased, the score attainability also can be controlled for maintaining the score value and thus inspiring the player to chase for higher score.

For achieving the object described above, the present invention includes a game system and method. The game system includes a game machine, a game judge unit and a symbol judge and change unit. The game machine has plural wheels arranged in an array for constituting a symbol set, and each wheel in the symbol set shows a symbol randomly. Moreover, the game judge unit judges if the symbols of the symbol set conform to a particular rule, and if the symbol set conforms to the particular rule, a particular amount of bonus game is provided for the game machine. Then, the game machine runs the bonus game, in which each wheel in the symbol set is capable of showing the super symbol randomly. Furthermore, the symbol judge and change unit judges the appearance of super symbol and defines a particular position for the wheel showing the super symbol, and finally, the symbol judge and change unit forces the symbols on the wheels at the right side, the left side, the upper side and the lower side of the particular position to change into an universal symbol respectively for increasing the score.

Accordingly, the present invention utilizes a dual mechanism of bonus game and automatic super symbol expansion, on one hand, the super symbol expansion can improve the enjoyment for player, and on the other hand, the quantity of bonus game can properly limit the score attainability, so that not only the enjoyment of player can be increased, the obtainment of score also can be controlled for maintaining the score value and thus inspiring the player to chase for higher score.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a structural view showing the appearance of the present invention;

FIG. 2 is a schematic view showing the symbol set of the present invention;

FIG. 3 is a schematic view showing the expansion of super symbol according to the present invention;

FIG. 4A˜FIG. 4C are schematic views showing the expansion of super symbol in another embodiment according to the present invention;

FIG. 5A˜FIG. 5C are schematic views showing the expansion of super symbol in another further embodiment according to the present invention;

FIG. 6 is a flow chart showing the operation procedure of the game machine according to the present invention;

FIG. 7 is flow chart showing the procedure of bonus game according to the present invention; and

FIG. 8 is a schematic view showing another embodiment of the present invention.

### DESCRIPTION OF THE PREFERRED EMBODIMENT

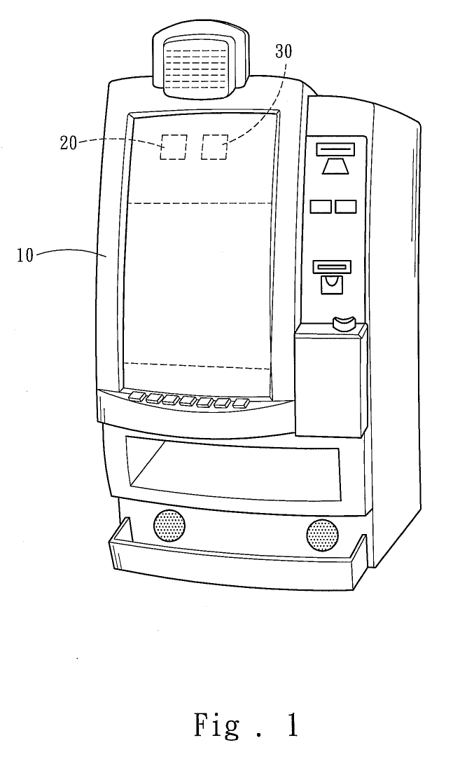

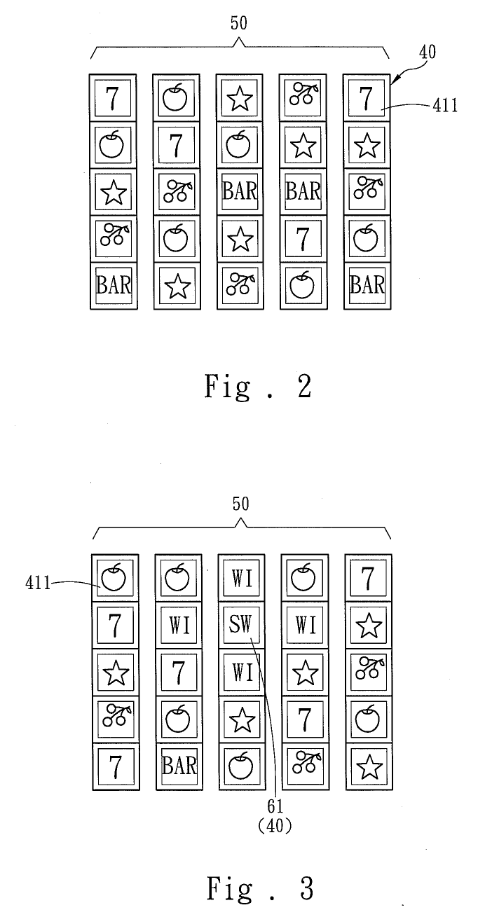

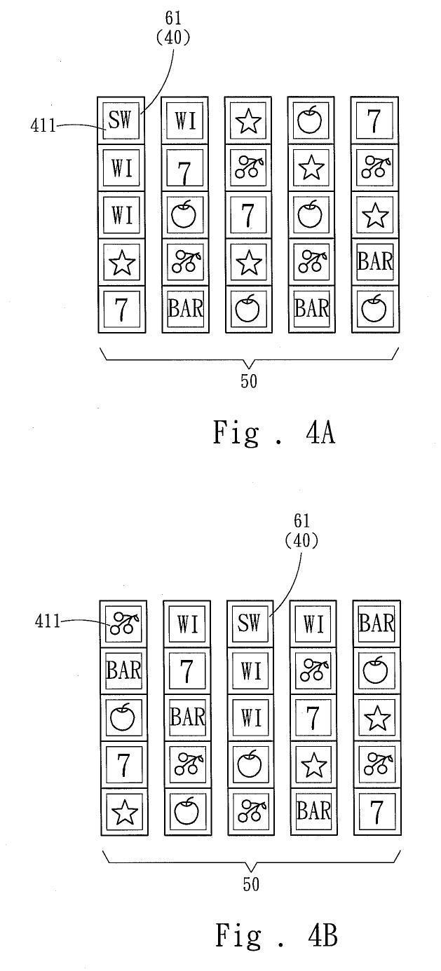

Please refer to FIG. 1, FIG. 2 and FIG. 3. The embodiment of the present invention includes a game machine 10, a game judge unit 20 and a symbol judge and change unit 30, wherein the game machine 10 has plural wheels 40, which are arranged in an array so as to constitute a symbol set 50, and each wheel 40 in the symbol set 50 includes all kinds of symbols 411 which are randomly shown. The quantity of wheels 40 is preferably 25, as shown in this embodiment, so as to form a 5×5 array, or it also can be a 5×3 or 5×4 array.

The game judge unit 20 and the symbol judge and change unit 30 are in the game machine 10. The game judge unit 20 can provide a particular amount of bonus games on the game machine 10 for the player as judging the symbols 411 in the symbol set 50 to conform to the particular rule. Then, when the game machine 10 runs the bonus game, each wheel 40 can randomly show a super symbol (SW). Moreover, the symbol judge and change unit 30 judges the appearance of SW and defines a particular position 61 for the wheel 40 with SW after the SW shows. Besides, the symbol judge and change unit 30 also can force the wheels 40 around the particular position 61 (at the upper side, the lower side, the right side and the left side) to change into universal symbol (WI).

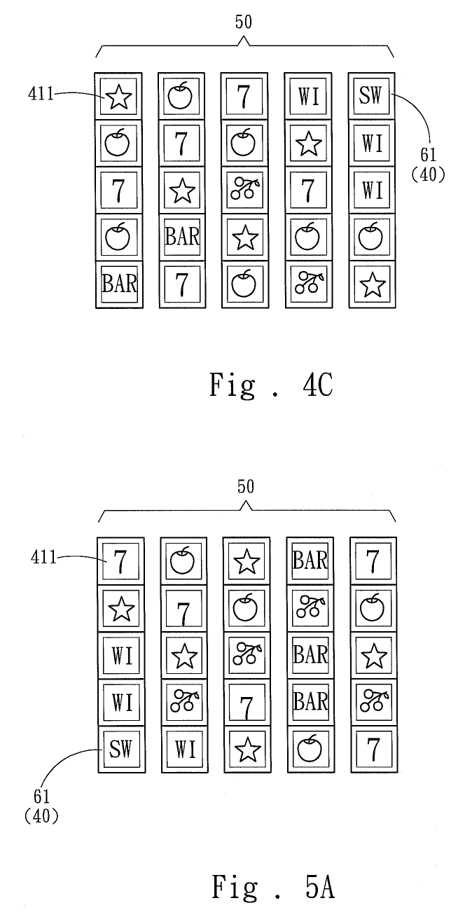

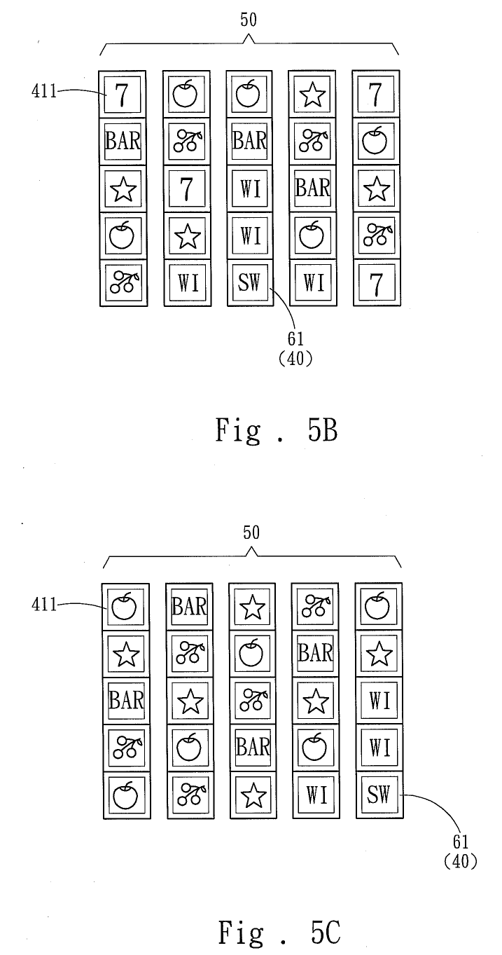

As shown in FIGS. 4A˜4C and FIGS. 5A˜5C, for increasing the quantity of SW, if the particular position 61 is located at the uppermost (as shown in FIGS. 4A˜4C), the symbol judge and change unit 30 will force the symbols on wheels at the left side, the right side and the two lower positions of the particular position 61 to change into WI, and further, if the particular position 61 is located at the lowermost (as shown in FIGS. 5A˜5C), the symbol judge and change unit 30 will force the symbols on wheels at the left side, the right side and the two upper positions of the particular position 61 to change into WI.

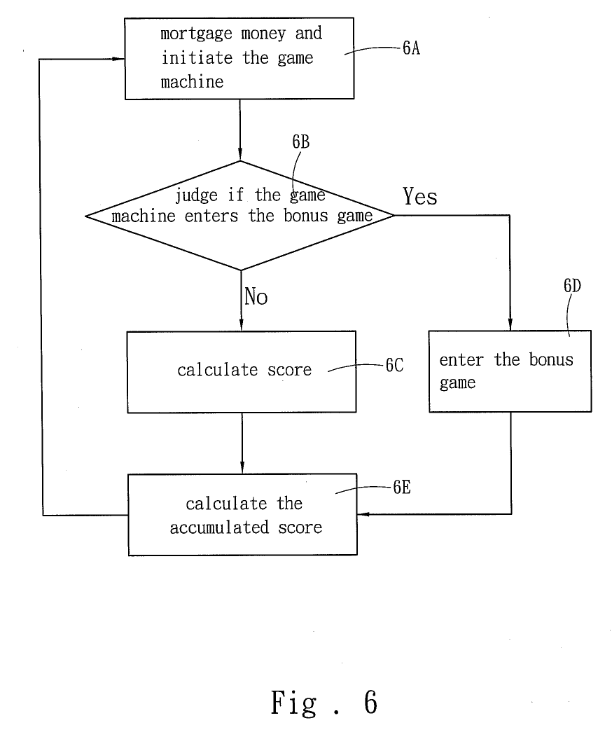

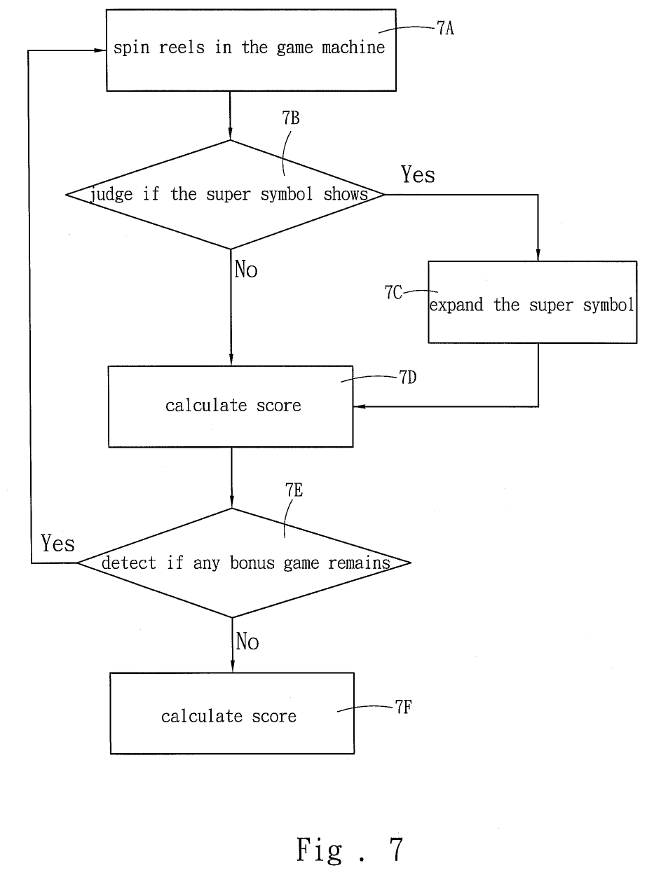

Please further refer to FIG. 6, which shows the flow chart of the method of the present invention. In step 6A, the user gambles to initiate the game machine 10, and then, the game machine 10 randomly produces a symbol set 50. In step 6B, it judges that if the symbols 411 of the symbol set 50 conform to a particular rule. If conforming to the particular rule, for example, the accumulated score reaches the threshold or a particular combination of symbols 411 in the symbol set 50 conforms to the particular rule, then the flow goes to step 6D and a particular amount of bonus games are provided. Then, as shown in FIG. 7, oppositely, if not conforming, the flow is followed by step 6C for calculating the score of alignment. Finally, in step 6E, the final score is calculated. Then, the user can initiate another round of game.

Continuously, please refer to FIG. 7, which shows the flow chart of the bonus game in the present invention. First, in step 7A, in the bonus game, each wheel 40 in the symbol set 50 can randomly show a super symbol (SW). In step 7B, the symbol judge and change unit 30 judges the appearance of SW and defines a particular position 61 for the wheel 40 with SW after the SW shows. Then, if the SW shows, the flow goes to step 7C, in which the symbol judge and change unit 30 expands the SW, namely, the wheels 40 around the SW are changed to show WI. Following, in step 7D, the score is calculated. In step 7E, it detects that is there any amount of bonus game remained. If yes, then the flow goes back to step 7A. This flow is repeated until the amount of bonus game is used up. Finally, the flow goes to step 7F for calculating the total score gained in the bonus game(s).

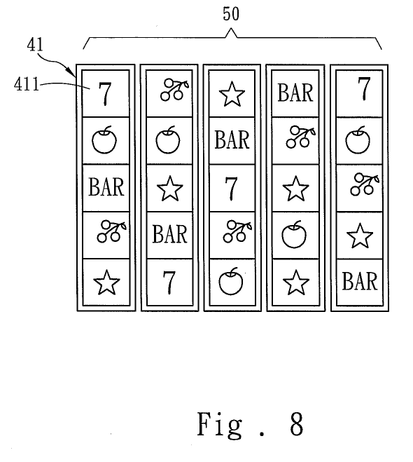

Moreover, as shown in FIG. 8, the plural wheels 41 in the present invention also can have plural symbols 411 arranged in a vertical direction, and the plural wheels 41 can be arranged side by side so that the plural symbols 411 can form an array arrangement, thereby producing the symbol set 50.

In the aforesaid, the present invention utilizes the dual mechanism of bonus game and automatic super symbol (SW) expansion, on one hand, the SW expansion can improve the enjoyment for player, and on the other hand, the qualification of bonus game and the quantity of bonus game can properly limit the score attainability, so that not only the enjoyment of player can be increased, the obtainment of the score also can be controlled for maintaining the score value and thus inspiring the player to chase for higher score.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A game system capable of changing symbols with a shown super symbol, comprising:
a game machine, having plural wheels arranged in an array for constituting a symbol set, wherein each wheel in the symbol set shows a symbol randomly;
a game judge unit, providing a particular amount of bonus game for the game machine as judging the symbols of the symbol set conform to a particular rule, wherein when the game machine runs the bonus game, each wheel in the symbol set is capable of showing the super symbol randomly; and
a symbol judge and change unit, forcing the symbols on the wheels at the right side, the left side, the upper side and the lower side of the particular position to change into an universal symbol respectively.

2. The game system as claimed in claim 1, wherein when the particular position is located at the uppermost position of the array, the symbol judge and change unit forces the symbols on the wheels at the left side, the right side and the two lower positions of the particular position to change into the universal symbol.

3. The game system as claimed in claim 1, wherein when the particular position is located at the lowermost position of the array, the symbol judge and change unit forces the symbols on the wheels at the left side, the right side and the two upper positions of the particular position to change into the universal symbol.

4. The game system as claimed in claim 1, wherein the quantity of the wheels is 25 so as to form a 5×5 array.

5. The game system as claimed in claim 1, wherein each of the plural wheels has plural symbols arranged in a vertical direction and the plural wheels are arranged side by side, so that all the symbols of the plural wheels are arranged in an array to form the symbol set.

6. A game method capable of changing symbols with a shown super symbol, comprising steps of:
gambling to initiate a game machine to run, wherein the game machine has plural wheels arranged in an array for constituting a symbol set, and each wheel in the symbol set shows a symbol randomly;
judging if the symbols of the symbol set conform to a particular rule by a game judge unit, and if the symbol set conforms to the particular rule, providing a particular amount of bonus game for the game machine, and if not, calculating alignment and accumulating score so as to proceed a next round of game;
running the bonus game through the game machine, wherein each wheel in the symbol set is capable of showing the super symbol randomly; and
through a symbol judge and change unit, judging the appearance of the super symbol, defining a particular position for the super symbol, and forcing the symbols on the wheels at the right side, the left side, the upper side and the lower side of the particular position to change into an universal symbol respectively, and then, calculating the score; and
detecting if any bonus game remains and repeating the bonus game until the bonus game is used up, and accumulating the calculated score of bonus game.

7. The method as claimed in claim 6, wherein when the particular position is located at the uppermost position of the array, the symbol judge and change unit forces the symbols on the wheels at the left side, the right side and the two lower positions of the particular position to change into the universal symbol.

8. The method as claimed in claim 6, wherein when the particular position is located at the lowermost position of the array, the symbol judge and change unit forces the symbols on the wheels at the left side, the right side and the two upper positions of the particular position to change into the universal symbol.

9. The method as claimed in claim 6, wherein the quantity of the wheels is 25 so as to form a 5×5 array.

10. The method as claimed in claim 6, wherein the plural wheels have plural symbols arranged in a vertical direction and the plural wheels are arranged side by side, so that all the symbols of the plural wheels are arranged in an array to form the symbol set.
